(19) United States
(12) Patent Application Publication
(10) Pub. No.: US 2013/0080907 A1
(43) Pub. Date: Mar. 28, 2013

(54) METHOD AND SYSTEM FOR A PERSONALIZED CONTENT PLAY LIST

(71) Applicants: Richard Skelton, Los Angeles, CA (US); Jason Rosenthal, Los Angeles, CA (US); Eric Wilson, Los Angeles, CA (US); Patrick Kennedy, West Hollywood, CA (US); Stephanie L. Grossman, Santa Monica, CA (US)

(72) Inventors: Richard Skelton, Los Angeles, CA (US); Jason Rosenthal, Los Angeles, CA (US); Eric Wilson, Los Angeles, CA (US); Patrick Kennedy, West Hollywood, CA (US); Stephanie L. Grossman, Santa Monica, CA (US)

(21) Appl. No.: 13/625,839

(22) Filed: Sep. 24, 2012

Related U.S. Application Data
(60) Provisional application No. 61/538,756, filed on Sep. 23, 2011.

(51) Int. Cl. G06F 3/01

(52) U.S. Cl. 715/738

(57) ABSTRACT

The present invention provides a method for presenting content information to a user. The method includes receiving a filter selection and applying by a processor the filter selection to metadata of available content to form a hierarchical presentation of the available content. The method also includes providing the hierarchical presentation of the available content for display to the user. A system is provided for presenting content information to a user that includes a viewing history database. The system also includes an available content index including data concerning available content. The system further includes a recommendation engine adapted to access the viewing history database and form a reordered available content index by applying at least one filter selection to metadata of the available content. A non-transitory computer readable medium having recorded thereon a program is provided.

### CROSS REFERENCE TO RELATED APPLICATIONS

This Non-Provisional U.S. Patent Application claims the benefit of U.S. Provisional Patent Application Ser. No. 61/538,756 filed on Sep. 23, 2011, entitled “Personalized Content Play List Based on Available Time and Viewer Mood” which is hereby incorporated by reference herein in its entirety.

### FIELD OF THE INVENTION

The present invention relates generally to content organization, and in particular relates to systems and methods for personalizing a content play list based on specified factors.

### BACKGROUND

Content is often presented to a user in alphabetical order, chronological order of broadcast or recording, or alternatively in sequential order of presentation. Alternatively, content may be presented in channels to a user for selection.

For example, television listings often show programs (i.e., content) in a static grid arranged with the time of day on one axis and the numerical order of channels on the other axis

### SUMMARY OF THE INVENTION

Systems, methods and media are provided herein for a content play list user interface for set-top boxes, computers, tablets, mobile phones and other devices. The content play list user interface is based on a user's individual, personalized tastes, the user's current mood and/or the time that they have available to consume the content.

According to exemplary embodiments, the present invention provides a method for presenting content information to a user. The method includes receiving a filter selection and applying by a processor the filter selection to metadata of available content to form a hierarchical presentation of the available content. The method also includes providing the hierarchical presentation of the available content for display to the user.

A system is provided for presenting content information to a user that includes a viewing history database. The system also includes an available content index including data concerning available content. The system further includes a recommendation engine adapted to access the viewing history database and form a reordered available content index by applying at least one filter selection to metadata of the available content.

A non-transitory computer readable medium having recorded thereon a program is provided. The program when executed causes a computer to perform a method for presenting content information to a user. The method includes receiving a filter selection. The method also includes applying the filter selection to metadata of available content to form a hierarchical presentation of the available content. The hierarchical presentation of the available content maximizes a likelihood of a user preference for content presented earlier in the hierarchical presentation. The method further includes providing the hierarchical presentation of the available content for display to the user.

These and other advantages of the present invention will be apparent when reference is made to the accompanying drawings and the following description.

### BRIEF DESCRIPTION OF THE DRAWINGS

FIG. 1 illustrates an exemplary device for practicing aspects of the present technology.

FIG. 2 illustrates an exemplary system including an exemplary device for practicing aspects of the present technology.

FIG. 3 is a flow chart illustrating an exemplary method for practicing aspects of the present technology.

FIGS. 4A to 4G illustrate graphical user interfaces for interacting with an exemplary device for practicing aspects of the present technology.

FIG. 5 an exemplary computing device that may be used to implement an embodiment of the present technology.

### DETAILED DESCRIPTION OF EXEMPLARY EMBODIMENTS

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated. According to exemplary embodiments, the present technology relates generally to content organization and delivery systems. More specifically, the present invention provides a system and method for personalizing a content play list based on specified factors. Though most of the following examples relate to video content, the invention is applicable to any content, for instance audio and/or written content.

Television listing user interfaces are used to organize content for set-top boxes, computers, tablets, mobile phones and other devices that display channels and programs (i.e., content). Conventional user interfaces may present content in a static grid list arranged by the time of day on one axis and the numerical order of channels available (for instance, to a subscriber of a cable system) on the other axis. Users may be able to navigate forward in time on the grid interface to see what will be shown on a certain channel or grouping of channels in the future, and they may navigate through all available channels to see what is on at any given time. Users may also manually enter in a channel number to see what is on that particular channel in the grid listing interface. There may be hundreds or thousands of channels within a cable system for a user to choose from, and each channel may show 48 or more programs per day.

Additionally, users now have the opportunity to access programs from the Internet, streaming movies and other forms of content from digital providers and services, video on demand from their cable provider, or otherwise, as well as from their own collection of personal videos and owned or stored programming.

The current grid TV user interface is not well equipped to allow a user to easily find the content that is right for them among the overwhelming choice of programming available at any time of the day. In the existing paradigm, users must either know what they want to watch and enter a channel number manually, use a search utility, or they must scroll through hundreds or thousands of channels, websites and otherwise to discover the programming that they want to watch. Scrolling through all of these channels limits the occasion of content serendipity, is frustrating, and time-consuming for the user.

A Personalized Content Play List Based on Available Time and Viewer Mood (also referred to as a PCPL, a play list, a personalized content play list, a hierarchical presentation, and a recommended play list) is provided. A PCPL may comprise a user interface that displays a hierarchy of content that is currently available to be consumed by an individual user. Such content may be displayed in a prioritized rank order of the likelihood of the user to engage with each piece of content based on the user's derived individual taste and preferences, the user's derived or expressed current mood and the user's parameters for the time they have available to watch, which are also either derived or explicitly given. Embodiments of a PCPL may be used on a suitable display means, such as a TV (optionally in conjunction with a set-top box), desktop computer, notebook computer, netbook computer, tablet computer, smart phone, personal digital assistant, (universal) remote control, and the like.

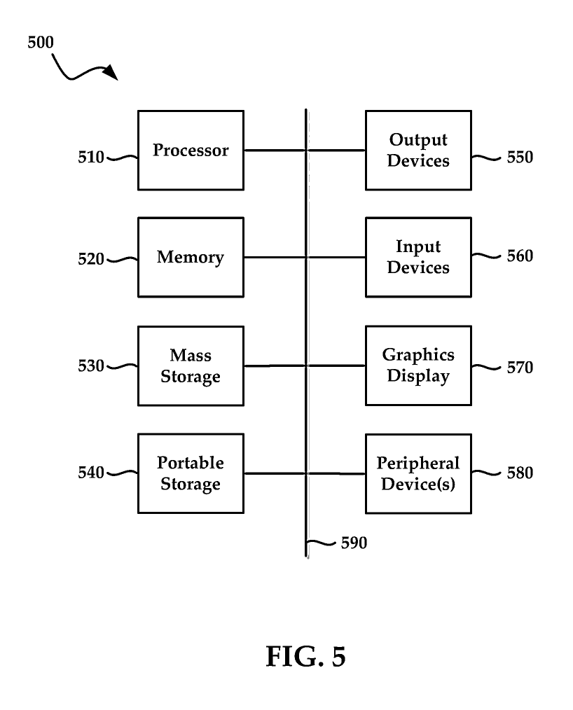

As may be appreciated by one of ordinary skill in the art, embodiments of the PCPL may, for example, be implemented on computing systems including a processor, memory, user input, and visual output. An exemplary computing system is described below in relation to FIG. 5.

There may be many types of content that can be arranged by the PCPL including, but not limited to: live, locally stored (e.g., taped), streamed, Video on Demand (VOD) programming. Programming may, for example, be a TV show, documentary, news program, performance, movie, web video clip, or other form of entertainment content. Programming may, for example, be accessible through a content provider, or from a personal collection of stored content on a computer, connected TV, digital content service, and the like. Programming may also be digitally encoded and optionally compressed video and audio (e.g., MPEG-1, MPEG-2, H.264, VC-2, AAC, AC-3, MP3, and the like).

The rank order of content in the PCPL may be derived by a recommendation engine (also referred to as an engine and a personalization engine). This engine, which may, for example, exist in a server environment and/or locally on the viewing device, receives, among other things, previous viewing behavior(s) exhibited by a user and renders them in a data store. The recommendation engine may apply algorithms to the stored user behavioral data, as well as content metadata, which may, for example, be stored or persisted locally and/or remotely in a data store, in order to analyze each individual user's content tastes/preferences and make predictions or recommendations of the content they are likely to consume. Metadata relating to moods may be culled from public databases relating to content (e.g., IMDB™ and/or Rotten Tomatoes™), and/or may be generated to correspond to the mood indicators of a PCPL.

Multiple variables may play a role in generating the derived predictions. For example, the particular time of the day and/or day of the week, the length of time the user has available to watch content at a particular time of day and/or day of the week, and the user's mood at a particular time of day and/or day of the week. Different types of user viewing behaviors may be used to generate derived predictions including, but not limited to: the programs that a user watches, does not watch, records, watches a preview of, rates, and shares on a social network.

Viewing behaviors may also include: the length of the programs the user watches, the length of time that the user spends watching, the time of day the user watches, the day of week that the user watches, the origin of the programming the user watches (e.g., live TV, DVD, VOD, and TV service such as Netflix™ and Hulu™, etc.) the type of device the user watches on, the delivery method of the programs the user watches (e.g., streaming video over a network, VOD, pay per view, live TV, etc.), and any combination of the preceding examples. Viewing behaviors may also include the viewing details about the programs the user watches such as the actors, directors, producers, locations, date of origin, etc. as well as the genre, synopsis, theme, mood related details, etc.

Additionally, a viewing behavior may include a behavior that does not manifest, (e.g., the user does not watch certain programming at certain times of the day and/or day of the week, from a certain origin, on a certain device, other negative characteristics reflecting the preceding examples, and the like.

A user may input the user's preferences for the length of time currently available to consume content as a selected filter and the user has the option to input the user's mood as a selected filter. These filters may then be used to dynamically reprioritize the content listings, which are provided by the recommendation engine, in the user interface.

There are different types of moods that may be derived by the recommendation/personalization engine and used to prioritize the content within the PCPL, including, but not limited to: mental states (e.g., happy, sad, romantic, etc.) content genre mood (e.g., in the mood for a war movie or a horror movie, comedy, drama, etc.); content type mood (e.g., mood to watch TV show, movie, web clip, etc.); content time mood (e.g., mood to watch a minute web clip, half hour TV show, hour TV show or a full length movie, etc.); consumption mood (e.g., in the mood to watch programming, browse programming, shop and buy programming, rent programming, tape programming for later, etc.)); and content device/location mood (e.g., mood for Netflix™ or other streaming service, live TV, internet, stored personal content, etc.).

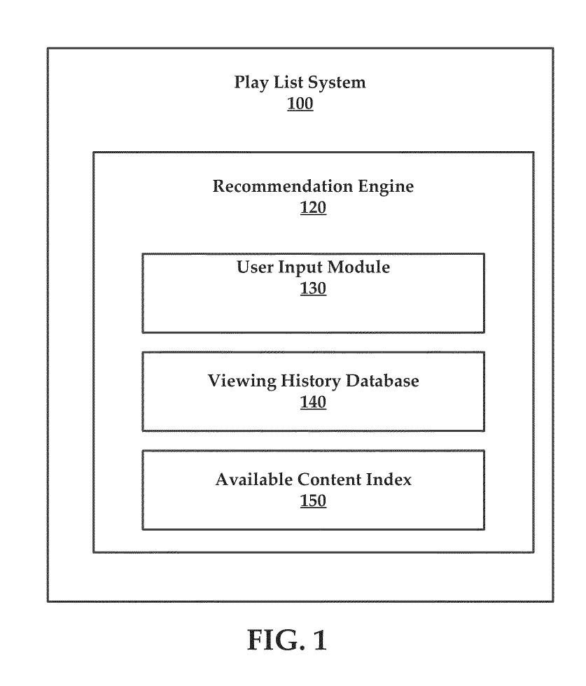

FIG. 1 illustrates an exemplary play list system 100 for practicing aspects of the present technology. Play list system 100 includes recommendation engine 120, which in turn includes user input module 130, viewing history database 140, and available content index 150. The system may include a display module adapted to receive reordered available content index and provide the reordered available content index to a user, via a tablet, smartphone or other display, including the display used to deliver the content. Play list system 100 may include a user input module adapted to receive a user input. The filter selection may be a duration of time available to the user to consume the content, and the duration of time may be received from the user and/or a historical user preference determined by the recommendation engine based on content consumption data of the user.

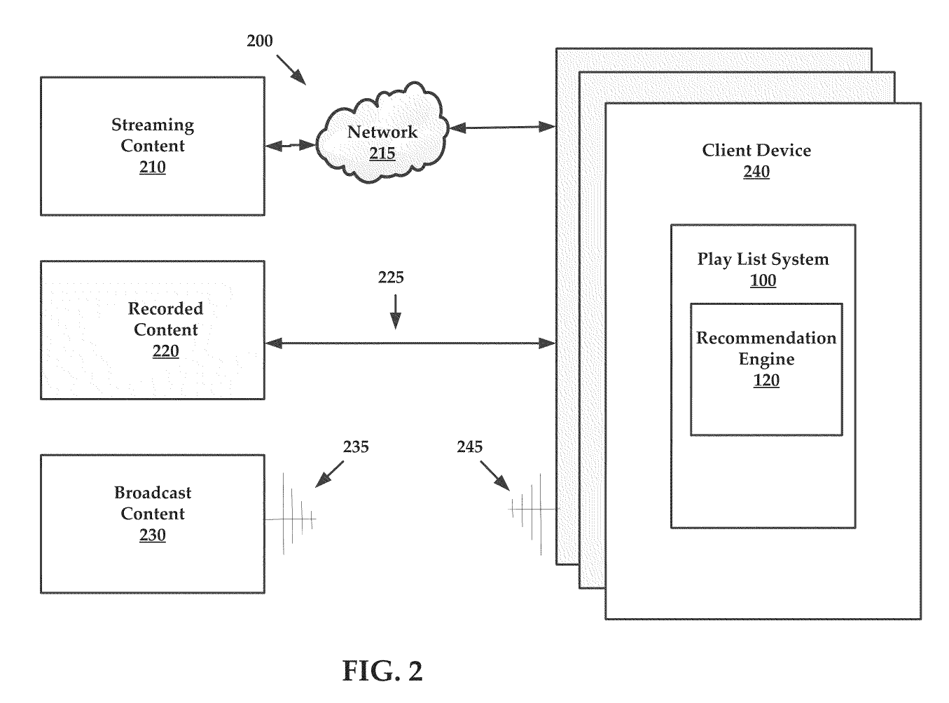

FIG. 2 illustrates an exemplary system 200 including play list system 100 for practicing aspects of the present technology. In FIG. 2, play list system 100 is software or firmware operating on client device 240. Client device 240 may be a television, monitor, computer, tablet computer, smartphone, or any other device having a processor and a display. In alternative exemplary embodiments, the display may be separate from client device 240, and/or play list system 100 may operate remotely in a cloud-based environment. Play list system 100 includes recommendation engine 120. Client device 240 may communicate over network 215 to access streaming content 210, may communicate over cable 225 to access recorded content 220, and/or may communicate over the airwaves using an antenna 245 on client device 240 and an antenna 235 on a broadcaster in order to access broadcast content 230.

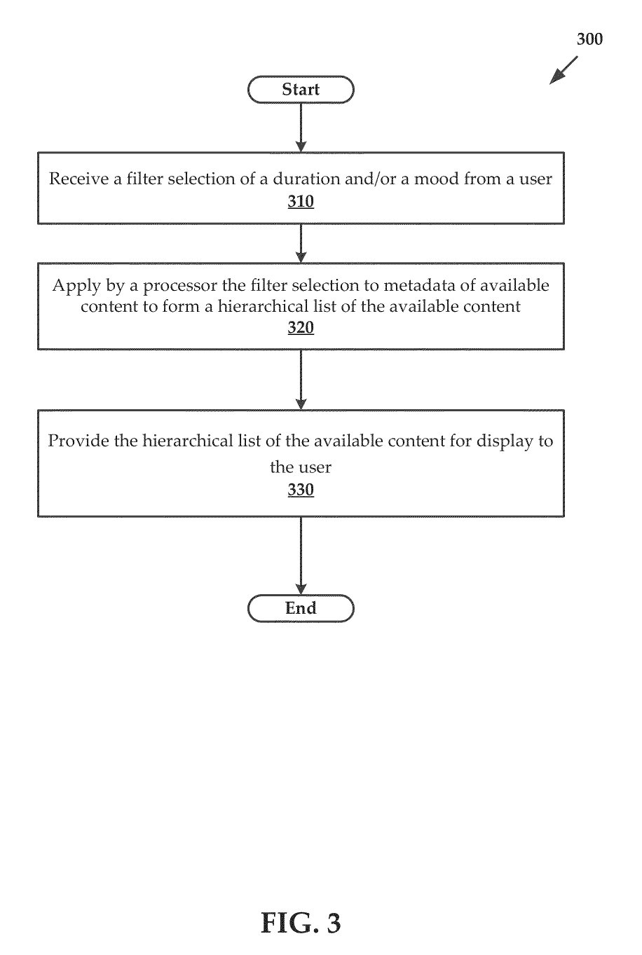

FIG. 3 illustrates method 300 for generating a play list based on time available and/or user mood. Method 300 starts at a start oval and proceeds to operation 310, which indicates to receive a filter selection of a duration and/or a mood from a user. In alternative exemplary embodiments, the filter selection may be made by a recommendation engine or another software system based on an algorithm, as described herein. From operation 310, the flow proceeds to operation 320, which indicates to apply by a processor the filter selection to metadata of available content to form a hierarchical list of the available content. From operation 320, the flow proceeds to operation 330, which indicates to provide the hierarchical list of the available content for display to the user. From operation 330, the flow proceeds to an end oval.

In method 300, a filter selection may be a duration of time available to the user to consume the content, and the duration of time may be received from the user and/or a historical user preference determined by a recommendation engine based on content consumption data of the user. When the duration of time is the historical user preference, the content consumption data may include a first user input associated with a time of day, a second user input associated with a day of the week, and/or a genre preference. The first user input and/or the second user input may be a mood input and/or a content consumption selection.

The filter selection may be a historical analysis of a user's past preferences, and the historical analysis may be determined by a recommendation engine based on content consumption data of the user. The filter selection may be a mood of the user that is input by the user, and the user may set a slider on a scale from low to high on at least one mood indicator. The at least one mood indicator may be at least two mood indicators, and the at least two mood indicators include at least two of dark, witty and dry.

The filter selection may be a mood of the user determined by a recommendation engine based on content consumption data of the user, and the content consumption data of the user may include a first user input associated with a time of day, a second user input associated with a day of the week, and/or a genre preference. The first user input and/or the second user input may be a mood input and/or a content consumption selection.

The available content may include broadcast television, cable television, streaming video, audio content, and DVR-accessible video. The hierarchical presentation of the available content may maximize a likelihood of a user preference for content presented earlier in the hierarchical presentation.

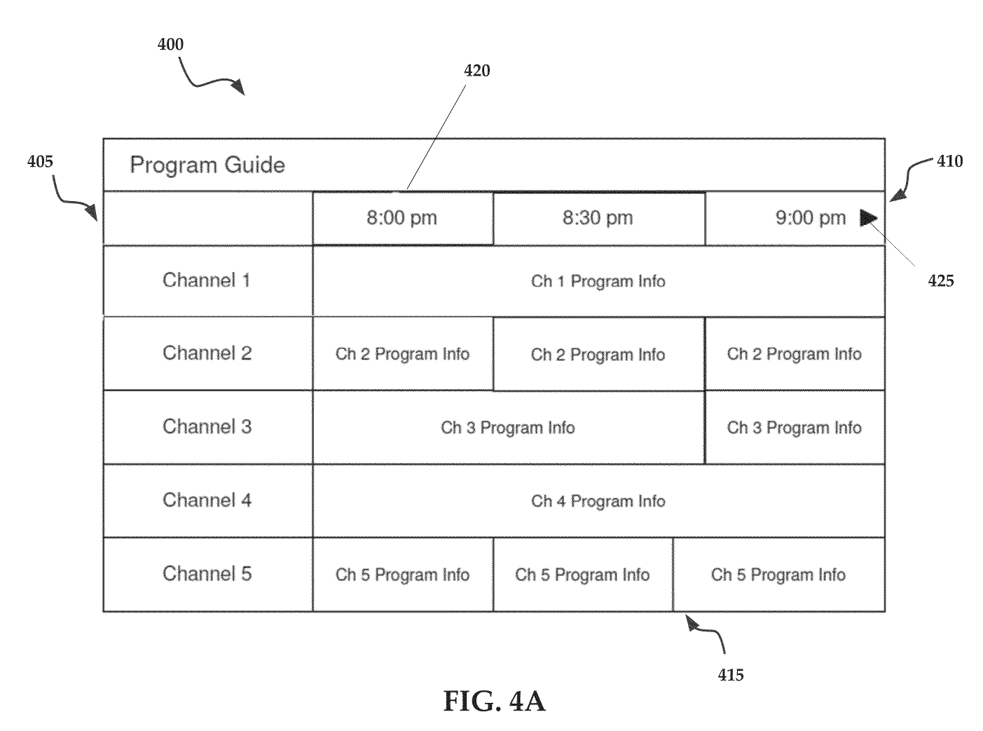

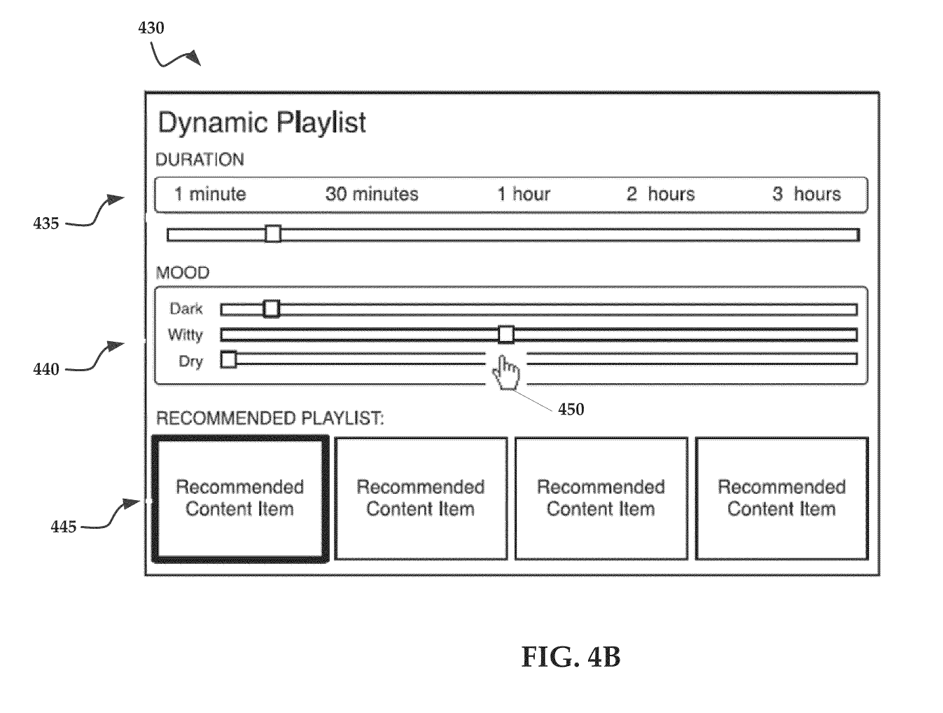

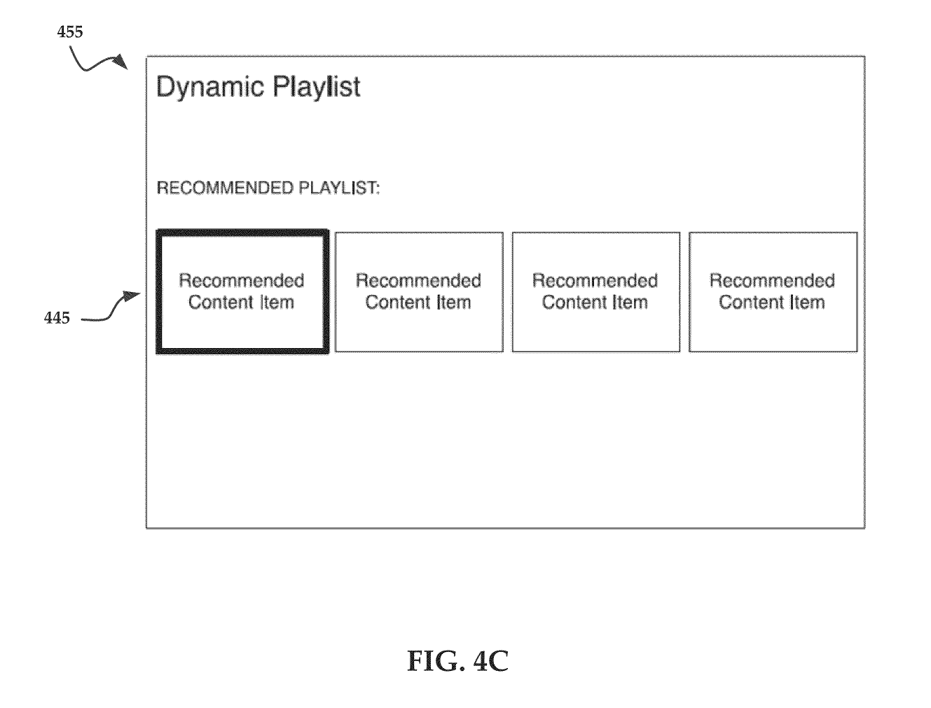

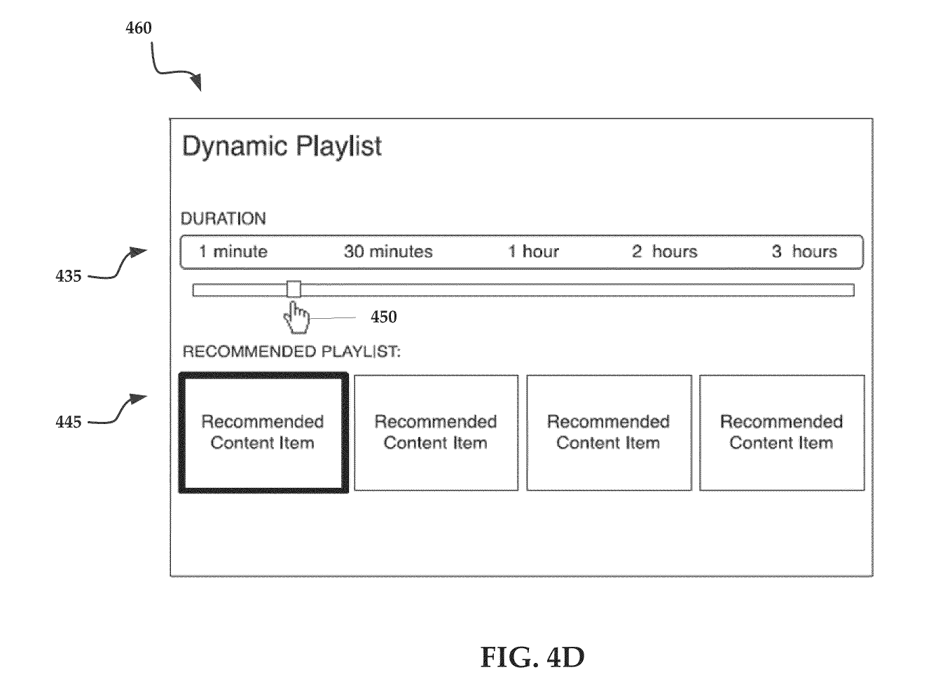

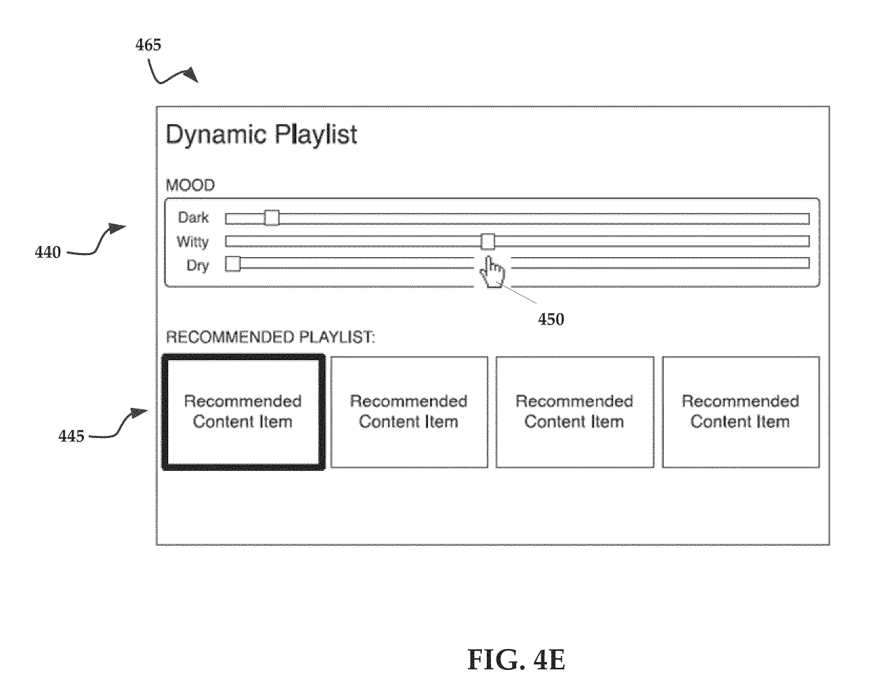

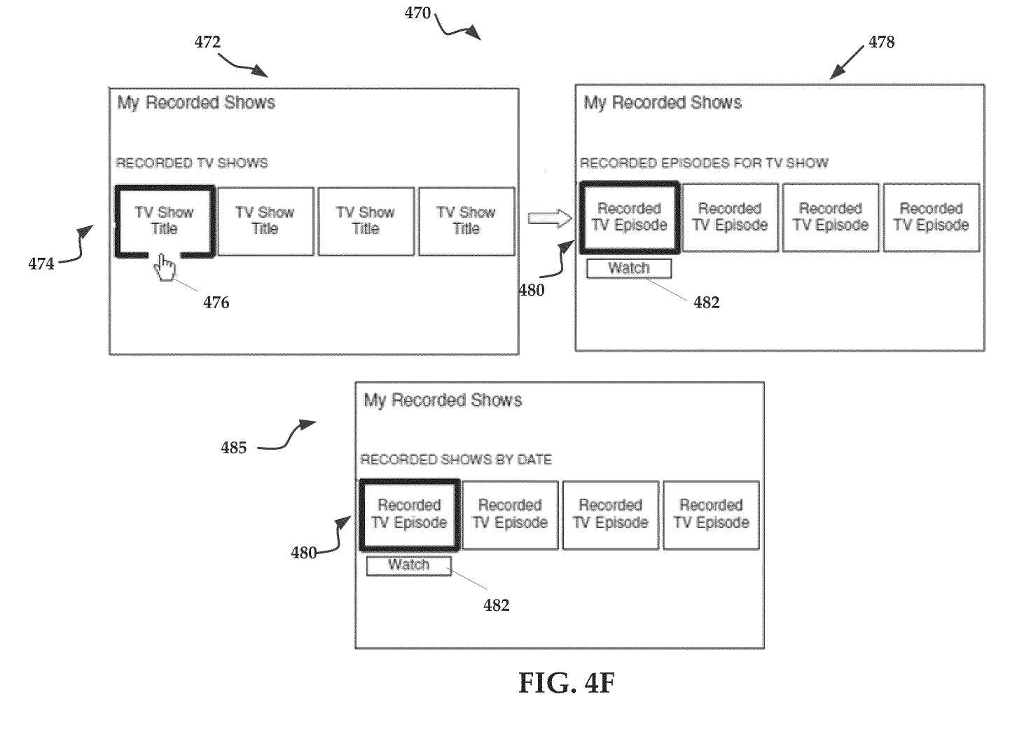

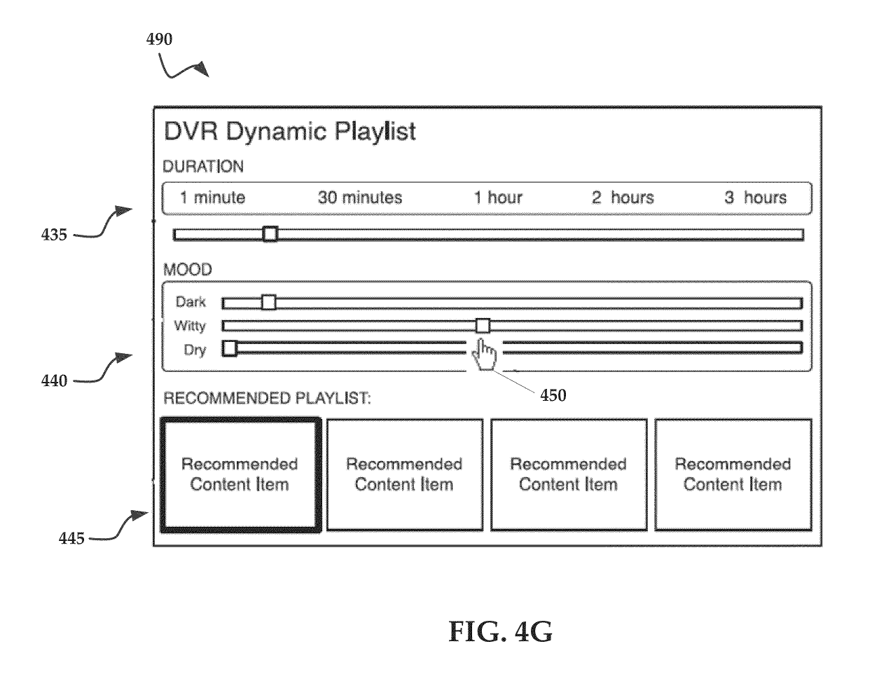

FIG. 4A is a graphical user interface of a conventional TV programming guide grid. Programming guide grid 400 includes channel axis 405 orthogonal to time axis 410, and content display 415. Current time slot 420 may be positioned in a default mode at the lowest, leftmost, timeslot. Current time slot 420 may indicate and/or describe programming currently being broadcast. Forward control 425 may enable a user to go forward in time in the programming guide listings. Programming guide grid 400 disadvantageously has a static order of channels for which programming is shown, and provides only channel-based scheduling for current and upcoming programming.

FIG. 4B is a graphical user interface of a first personalized content play list 430 (first PCPL 430). First PCPL 430 in FIG. 4B is based on available time and viewer mood. First PCPL 430 is a dynamic play list user interface allowing time (e.g., duration) and mood to be used as parameters to generate a personalized play list of content. Duration input 435 enables user 450 to adjust the desired duration of time for the generated play list. For example, user 450 may slide a slider along a time bar from one minute up to three hours or more to indicate the amount of time they have available for viewing or otherwise consuming content. Content that is longer than the selected period is not displayed on the play list. In some embodiments, all content having a shorter playing period are displayed in the generated list, while in other exemplary embodiments only shows or movies having a length shorter than the selected duration but substantially equal to the time available are selected.

Mood input 440 enables user 450 to adjust one or more mood indicators for the generated play list. For example, user 450 may slide a slider along three different mood indicators, for example, “dark”, “witty”, and/or “dry”, with the slider position indicating more or less. For example, the slider in mood indicator “dry” all the way to the right of first PCPL 430 indicates that dry humor is not a desired trait of the content in the play list that is presented. Alternatively, a slider for mood indicator “witty” may be positioned centrally by user 450 indicating that the user desires somewhat witty, moderately witty, or some witty content to be presented in the play list. In this way, mood can be specified relative to a combination of multiple other moods, or as a solitary selection. Additionally, user 450 can adjust the amount or weight of the mood attribute of interest. A recommendation engine may use mood input 440 as a filter to be applied against metadata of available content. For example, with the “dry” mood indicator positioned far to the right, indicating that dry is not a required feature, the recommendation engine may eliminate content having metadata indicating that it is considered “dry”, or alternatively, the recommendation engine may simply not use “dry” as a selection criteria. The recommendation engine will produce and display on first PCPL 430 a recommended play list 445 showing rank ordered content, which is generated based on the specified time and mood attributes.

An exemplary embodiment may omit user-initiated selection of “filters”, and may inherently use the recommendation engine's predictions to prioritize the user interface. In this embodiment, the recommendation engine may derive and predict the content that a user is most likely to consume, the current mood of the user, and the time they have available to consume, at least based in part on the user's previously exhibited behavior(s). In this embodiment, the user is not required to select filters, because the play list user interface may reflect what the recommendation/personalization engine determines about a user.

FIG. 4C is a graphical user interface of a second personalized content play list 455 (second PCPL 455). Second PCPL 455 in FIG. 4C is based on implicitly derived available time and implicitly derived viewer mood. Since the duration of time available and the viewer mood are both implicitly derived, there are no user inputs shown in second PCPL 455. Recommended play list 445 of rank ordered content is generated based on implicitly derived mood and implicitly derived time available for the current user according to previously exhibited user behavior. For example, given a time of day and day of the week, which the recommendation engine may access via an internal clock, the internet, or any other appropriate method, the recommendation engine may surmise from past viewing on the same day at the same time, that the user enjoys shows of a particular length and/or a particular mood quality. Alternatively, the selection may be filtered by genre and/or show style (e.g., sitcom, talk show, drama). With no user inputs required, second PCPL 455 may continually update recommended play list 445 during the day to display the content that a user is most likely interested in seeing at that time of day.

In an exemplary embodiment, the user may provide input(s) related to the user's preference(s) for the time(s) that they have available to consume content. In this embodiment, the recommendation/personalization engine may predict the content that a user is most likely to consume, as well as the current mood of the user based on the user's previously exhibited behavior(s).

FIG. 4D is a graphical user interface of a third personalized content play list 460 (third PCPL 460). Third PCPL 460 in FIG. 4D is based on available time and implicitly derived viewer mood. Duration input 435 enables user 450 to adjust the desired duration of time for the generated play list. For example, user 450 may slide a slider along a time bar from one minute up to three hours or more to indicate the amount of time they have available for viewing or otherwise consuming content. Content that is longer than the selected period is not displayed on the play list. In some embodiments, all content having a shorter playing period are displayed in the generated list, while in other exemplary embodiments only shows or movies having a length shorter than the selected duration but substantially equal to the time available are selected.

Recommended play list 445 of rank ordered content is generated based on implicitly derived mood (derived from previously exhibited behavior) and time available for the current user according to the time slider selection of duration input 435. For example, given a time of day and day of the week, which the recommendation engine may access via an internal clock, the internet, or any other appropriate method, the recommendation engine may surmise from past viewing on the same day at the same time, that the user enjoys shows of a particular mood quality, which may be further filtered based on the selected time duration input by the user.

In exemplary embodiments, the user may provide input(s) related to the user's preference(s) for the user's current mood to be used as a filter for content they want to consume. In this embodiment, the recommendation engine may be used to derive and predict the time the user has available to consume content, based on the user's previously exhibited behavior(s).

FIG. 4E is a graphical user interface of a fourth personalized content play list 465 (fourth PCPL 465). Fourth PCPL 465 in FIG. 4E is based on implicitly derived available time and viewer mood. Mood input 440 enables a user to adjust one or more mood indicators for the generated play list. For example, user 450 may slide a slider along three different mood indicators, for example, “dark”, “witty”, and/or “dry”, with the slider position indicating more or less. Mood can be specified relative to a combination of multiple other moods, or as a solitary selection. Additionally, user 450 can adjust the amount or weight of the mood attribute of interest. A recommendation engine may use mood input 440 as a filter to be applied against metadata of available content.

Recommended play list 445 of rank ordered content is generated based on mood (based on the user input on the mood input 440) and according to the implicitly derived time available for the current user according to previously exhibited behavior. For example, given a time of day and day of the week, which the recommendation engine may access via an internal clock, the internet, or any other appropriate method, the recommendation engine may surmise from past viewing on the same day at the same time, that the user enjoys shows of a particular mood quality, which may be further filtered based on the selected time duration input by the user.

FIG. 4F illustrates two graphical user interfaces of conventional DVR programming lists. Common DVR interfaces consist of hierarchical organization of recorded content. Recorded programming is commonly organized in a top-down scheme or folder structure requiring the user to start at a high level such as TV Series. Folder structure system 470 for a DVR includes a top level screen 472 having content categories 474, for instance a particular TV series (e.g., “Star Trek”, “Breaking Bad”, etc.). The user must then select a desired top-level node, such as a particular TV series in order to drill down to an associated list of recorded content. By selecting via user input 476 one of the TV shows in content categories 474, content level screen 478 is displayed, including content records 480, which may be TV show episodes arranged in chronological order of broadcast or recording. A list of recorded programming is subsequently presented, usually in chronological order. A user is presented with watch button 482 on content level screen 478, enabling command of the content delivery device (for instance a TV) for delivery of a specified one of content records 480.

Some DVR interfaces may have a flat hierarchical scheme 485 in which content records 480 across all TV shows are shown in order of the recording date. A user is presented with watch button 482 on flat hierarchical scheme 485, enabling command of the content delivery device (for instance a TV) for delivery of the specified content.

In still further exemplary embodiments, the PCPL may be applied to the play list of “taped” content. Taped content may be content that a user has selected manually or is otherwise to be stored on a recording or storage device, such as a digital video recorder (DVR) or cloud-based infrastructure, for later consumption. Currently, users see their taped content in a listing based on alphabetical order, or in order based on the day and time that the most recent content was recorded. The PCPL may allow the user to see the content the user recorded in an order based at least in part on the user's likelihood to watch, based on the user's time available, current mood, the user's previous viewing behaviors at a particular time of day or day of week, the user's previous behavior(s) within the user's taped content menu (e.g. if the user frequently watches a particular show from the user's queue before others.), and the like. These parameters may be, for example, be derived from a recommendation engine, and/or they can be explicitly expressed by the user.

FIG. 4G is a graphical user interface of a fifth personalized content play list 490 (fifth PCPL 490) for DVR content. Fifth PCPL 490 in FIG. 4G is based on available time and viewer mood. The user interface (UI) elements of fifth PCPL 490 enable the user to adjust the desired duration of time for the generated play list, and enable user 450 to specify the desired mood of the generated personalized play list. Mood can be specified relative to a combination of multiple other moods, or as a solitary selection, and the amount or weight of the mood attribute of interest can also be adjusted.

Fifth PCPL 490 is a dynamic play list user interface allowing time (e.g., duration) and mood to be used as parameters to generate a personalized play list of content. Duration input 435 enables user 450 to adjust the desired duration of time for the generated play list. For example, user 450 may slide a slider along a time bar from one minute up to three hours or more to indicate the amount of time they have available for viewing or otherwise consuming content. Content that is longer than the selected period is not displayed on the play list. Mood input 440 enables user 450 to adjust one or more mood indicators for the generated play list. For example, user 450 may slide a slider along three different mood indicators, for example, “dark”, “witty”, and/or “dry”, with the slider position indicating more or less. In this way, mood can be specified relative to a combination of multiple other moods, or as a solitary selection. Additionally, user 450 can adjust the amount or weight of the mood attribute of interest. A recommendation engine may use mood input 440 as a filter to be applied against metadata of available content. The recommendation engine will produce and display on fifth PCPL 490 a recommended play list 445 showing rank ordered content, which is generated based on the specified time and mood attributes.

FIG. 5 illustrates an exemplary computing system 500 that may be used to implement an embodiment of the present technology. Play list system 100 and/or client device 240 may include one or more of the components of computing system 500, and/or computing system 500 may be used to perform method 300 of FIG. 3. The computing system 500 of FIG. 5 includes one or more processors 510 and memory 520. Memory 520 stores, in part, instructions and data for execution by the one or more processors 510. Memory 520 can store the executable code when the computing system 500 is in operation. The computing system 500 of FIG. 5 may further include a mass storage 530, portable storage 540, output devices 550, input devices 560, a graphics display 570, and other peripheral device(s) 580.

The components shown in FIG. 5 are depicted as being connected via a single bus 590. The components may be connected through one or more data transport means. The one or more processor 510 and memory 520 may be connected via a local microprocessor bus, and the mass storage 530, peripheral device(s) 580, portable storage 540, and graphics display 570 may be connected via one or more input/output (I/O) buses.

Mass storage 530, which may be implemented with a magnetic disk drive or an optical disk drive, is a non-volatile storage device for storing data and instructions for use by processor 510. Mass storage 530 can store the system software for implementing embodiments of the present technology for purposes of loading that software into memory 520.

Portable storage 540 operate in conjunction with a portable non-volatile storage medium, such as a floppy disk, compact disk or digital video disc, to input and output data and code to and from the computing system 500 of FIG. 5. The system software for implementing embodiments of the present technology may be stored on such a portable medium and input to the computing system 500 via the portable storage 540.

Input devices 560 provide a portion of a user interface. Input devices 560 may include an alphanumeric keypad, such as a keyboard, for inputting alphanumeric and other information, or a pointing device, such as a mouse, a trackball, stylus, or cursor direction keys. Additionally, the system 500 as shown in FIG. 5 includes output devices 550. Suitable output devices include speakers, printers, network interfaces, and monitors.

Graphics display 570 may include a liquid crystal display (LCD) or other suitable display device. Graphics display 570 receives textual and graphical information, and processes the information for output to the display device.

Peripheral device(s) 580 may include any type of computer support device to add additional functionality to the computing system. Peripheral device(s) 580 may include a modem or a router.

The components contained in the computing system 500 of FIG. 5 are those typically found in computing systems that may be suitable for use with embodiments of the present technology and are intended to represent a broad category of such computer components that are well known in the art. Thus, the computing system 500 of FIG. 5 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method for presenting content information to a user, comprising:
receiving a filter selection;
applying by a processor the filter selection to metadata of available content to form a hierarchical presentation of the available content;
providing the hierarchical presentation of the available content for display to the user.

2. The method of claim 1, wherein:
the filter selection is a duration of time available to the user to consume the content; and
the duration of time is at least one of received from the user and a historical user preference determined by a recommendation engine based on content consumption data of the user.

3. The method of claim 2, wherein:
the duration of time is the historical user preference;
the content consumption data comprises at least one of:
a first user input associated with a time of day;
a second user input associated with a day of the week; and
a genre preference; and
at least one of the first user input and the second user input is at least one of a mood input and a content consumption selection.

4. The method of claim 1, wherein:
the filter selection is a historical analysis of a user's past preferences; and
the historical analysis is determined by a recommendation engine based on content consumption data of the user.

5. The method of claim 1, wherein:
the filter selection is a mood of the user that is input by the user; and
the user sets a slider on a scale from low to high on at least one mood indicator.

6. The method of claim 5, wherein:
the at least one mood indicator is at least two mood indicators; and
the at least two mood indicators include at least two of dark, witty and dry.

7. The method of claim 1, wherein:
the filter selection is a mood of the user determined by a recommendation engine based on content consumption data of the user;
the content consumption data of the user includes at least one of:
a first user input associated with a time of day;
a second user input associated with a day of the week; and
a genre preference; and
at least one of the first user input and the second user input is at least one of a mood input and a content consumption selection.

8. The method of claim 1, wherein the available content comprises at least one of:
broadcast television;
cable television;
streaming video;
audio content; and
DVR-accessible video.

9. The method of claim 1, wherein the hierarchical presentation of the available content maximizes a likelihood of a user preference for content presented earlier in the hierarchical presentation.

10. A system for presenting content information to a user, comprising:
a viewing history database;
an available content index comprising data concerning available content; and
a recommendation engine adapted to access the viewing history database and form a reordered available content index by applying at least one filter selection to metadata of the available content.

11. The system of claim 10, further comprising a display module adapted to receive reordered available content index and provide the reordered available content index.

12. The system of claim 10, further comprising:
a user input module adapted to receive a user input;
wherein the filter selection is a duration of time available to the user to consume the content; and
wherein the duration of time is at least one of received from the user and a historical user preference determined by the recommendation engine based on content consumption data of the user.

13. The system of claim 10, wherein:
the duration of time is the historical user preference;
the content consumption data comprises at least one of:
a first user input associated with a time of day;
a second user input associated with a day of the week; and
a genre preference; and
at least one of the first user input and the second user input is at least one of a mood input and a content consumption selection.

14. The system of claim 10, wherein:
the filter selection is a historical analysis of a user's past preferences; and
the historical analysis is determined by a recommendation engine based on content consumption data of the user.

15. The system of claim 10, wherein:
the filter selection is a mood of the user input by the user; and
the user sets a slider on a scale from low to high on at least one mood indicator.

16. The system of claim 10, wherein:
the at least one mood indicator is at least two mood indicators; and
the at least two mood indicators include at least two of dark, witty and dry.

17. The system of claim 10, wherein:
the filter selection is a mood of the user determined by a recommendation engine based on content consumption data of the user;
the content consumption data of the user includes at least one of:
a first user input associated with a time of day;
a second user input associated with a day of the week; and
a genre preference; and
at least one of the first user input and the second user input is at least one of a mood input and a content consumption selection.

18. The system of claim 10, wherein the available content comprises at least one of:
broadcast television;
cable television;
streaming video;
audio content; and
DVR-accessible video.

19. The system of claim 10, wherein the hierarchical presentation of the available content maximizes a likelihood of a user preference for content presented earlier in the hierarchical presentation.

20. A non-transitory computer readable medium having recorded thereon a program, the program when executed causing a computer to perform a method, the method for presenting content information to a user, the method comprising:
receiving a filter selection;
applying the filter selection to metadata of available content to form a hierarchical presentation of the available content, the hierarchical presentation of the available content maximizing a likelihood of a user preference for content presented earlier in the hierarchical presentation;
providing the hierarchical presentation of the available content for display to the user.
